(19) United States
(12) Patent Application Publication
(10) Pub. No.: US 2024/0301632 A1
(43) Pub. Date: Sep. 12, 2024

(54) TURF INFILL MATERIAL AND RELATED TURF

(71) Applicant: MONDO S.p.A., Alba Frazione Gallo (IT)

(72) Inventors: Irma NEDI, Alba Frazione Gallo (IT); Emanuele TESTA, Alba Frazione Gallo (IT); Maurizio STROPPIANA, Alba Frazione Gallo (IT)

(73) Assignee: MONDO S.p.A., Alba Frazione Gallo, CN (IT)

(21) Appl. No.: 18/546,337

(22) PCT Filed: Feb. 10, 2022
(86) PCT No.: PCT/IB2022/051205

§ 371 Date: Aug. 14, 2023

(30) Foreign Application Priority Data
Feb. 12, 2021 (IT) 102021000003140

(51) Int. Cl. E01C 13/08; C08L 101/16

(52) U.S. Cl. CPC E01C 13/08; C08L 101/16; C08L 2666/68

(57) ABSTRACT

Infill material for turf having at least one biodegradable biopolymer, at least one vegetable component and at least one plasticizer.

### FIELD OF THE INVENTION

The present invention relates to filling materials (or “fillers” or “infills”) for turfs and relative turfs.

### DESCRIPTION OF THE PRIOR ART

Synthetic and natural turf structures comprising a particulate infill material dispersed between the filiform formations have been known for some time. Filling materials (or infills) also defined as “stabilization infills” have the function of weighing down and stabilizing the turf. Some sports practiced on turf involve jumps, accelerations, slips, changes of direction or—on the contrary-require balance and stability. The lower limbs, therefore, engaged in sports activities are subjected to considerable stresses, and can withstand a load that can be equal to or greater than 3-5 times the weight of the same body. In this regard, infill materials defined as “performance infills” have characteristics that make them suitable for giving better playing performance, such as ball bouncing and rolling, and the ability to cushion the blows and falls of the players.

A synthetic grass structure comprises, under normal laying conditions, a planar substrate with a plurality of filiform formations, which extend upwards starting from the substrate itself, so as to simulate the natural turf. A particulate filling material, or infill, is dispersed between the filiform formations in such a way as to keep the latter in a substantially upright position. A turf of synthetic grass comprising infill material is described, for example, in the US patent U.S. Pat. No. 5,958,527.

The infill material helps support the grass fibers, adds ballast and provides an extra layer of fall protection for players. The filler responds to stresses of various kinds which it is subjected to, for example, static, dynamic, friction or wear stresses.

Infill materials known to date, comprising pure silica sand or coated with thermoplastic elastomers (TPE) may have drawbacks linked to the inhalation of the fine silica dust. Furthermore, these particular infill materials alone are not sufficient to ensure adequate playing comfort or to reduce the risk of injury due to shock absorption or rotational resistance.

Other infill materials may comprise shredded rubber powder from discarded tires. This solution has met with considerable commercial success, taking into account the wide availability and low cost of the material used. In relation to the use of this material, however, objections related to environmental protection have been raised: the rubber of used tires can potentially contain toxic substances, such as polycyclic aromatic hydrocarbons (PAHs) and heavy metals. Some PAHs, such as benzopyrene, may have a carcinogenic effect. Heavy metals, such as lead, zinc and cadmium may be harmful if released into the surrounding environment. In order to overcome the aforesaid drawbacks, solutions have been developed wherein the shredded rubber from discarded tires is coated with dyes, sealants or antimicrobial substances. These solutions, however, have not been efficient in reducing the harmful effects exerted on the environment.

Other types of filling materials may include Ethylene Propylene Diene Monomer (EPDM), a polymeric elastomer with high resistance to abrasion, wear, and high temperatures. Although considered safe and non-toxic, EPDM is not widely available as a recycled material, and as a virgin material it is very expensive.

Also known are infill materials made with granules of thermoplastic polymers, such as polyethylene and polypropylene, mixed with inorganic fillers such as talc, mica, bentonite, kaolin, perlite, calcium carbonate (CaCO₃), silica (SiO₂), wollastonite, clay, diatomite, titanium dioxide or zeolites. The inorganic filler is inserted into the mixture to increase the density of the thermoplastic polymers and—in some cases—to improve its thermal resistance by acting on the Heat Deflection Temperature (HDT). This type of filling material is cheap but does not, however, have the anti-fall performance for players, or rather, the ability to absorb shocks.

The use of the aforesaid filling materials for artificial or natural grass turfs has a number of drawbacks, which also affect the protection of environmental ecosystems, both marine and soil due to an involuntary dispersion of the components into the surrounding environment. During a sporting performance, for example, components of the infill material may become trapped in the soles of the players' shoes and consequently be involuntarily dispersed even outside the turf, into the surrounding environment. Similarly, as a result of atmospheric phenomena, such as rain and snow, the components of the aforesaid filler materials may be transported outside the field, dispersing into the environment without biodegrading.

Furthermore, with the passage of time, the decomposition of plastic and microplastics may result in pollution of the soil, of the aquifers, and of the marine ecosystem.

In order to overcome some of these drawbacks, filling materials have been made comprising granules consisting of biopolymers of the family of biodegradable aliphatic polyesters, for example, polylactic acid (PLA). These granules may also incorporate vegetable fibers or inorganic fillers into the matrix. This type of filling material, if used at over 10% in the mixture, would be biodegradable and compostable only under controlled conditions, for example, using industrial composters, but would not be biodegradable when the material is accidentally and involuntarily released into the soil surrounding the playing field.

Infill materials are also known comprising organic and vegetable compounds, such as, for example, natural cork, ground fibers, granules of cereal or coconut shells. At the end of their life cycle, these materials can be recycled into the environment and do not exert harmful effects if released directly into the soil. One example of such infill materials, described in WO 2011/024066 A2, comprises an organic material of plant origin consisting of a mixture of a defibrated tree material, which is resistant to microbial digestion, and cereal husks.

Other materials may include “natural” organic compounds, such as ground coconut, pecan shells, peanut shells, walnut shells, corn cobs or hard “stone” materials such as olive stones. The disadvantage of these components is related to the possibility that they represent sources of nourishment for microbial growth, molds, and insects such as termites.

The aforesaid infill materials, including voluminous and light organic vegetable components, due to their intrinsic nature, have a density much lower than that of water, generally between 0.15 gr/cm³ and 0.7 gr/cm³. As a result, in the case of rain, stagnation areas may form wherein the material may float on the turf. The consequent risk is that the infill material may move with respect to the original laying position or be dragged (washed away), causing an emptying of the turf. An “emptied” turf is no longer able to act as a fall “shock absorber”, with consequent dangerous effects also on the safety of users. These materials, therefore, require continuous maintenance, implying a constant and difficult to estimate expense item.

A further drawback related to the use of these materials is their poor elasticity; if subjected to dynamic and continuous loads, they lose compactness and may either defragment into smaller materials or compact, losing the characteristics they had at the time of laying.

### OBJECT AND SUMMARY OF THE INVENTION

The invention aims to overcome the aforesaid drawbacks by providing an infill material for natural or synthetic turfs, which has the characteristics of a polymeric performance infill material and—at the same time—of a completely vegetable infill material. The specific combination of its components, in the specific quantities, allows a material to be obtained with the performance characteristics described below that is free from harmful effects in terms of environmental impact.

In particular, the material subject of the present description has been shown to be able to respond to the mechanical stresses to which it is subjected, and to cushion the falls of the users. At the same time, it also has the advantage of being biodegradable on a par with a purely vegetable infill material as—at the end of its life—at least 90% is transformed into carbon dioxide (CO₂) and water (H₂O), without releasing microplastics and components that are toxic for the environment.

According to the present invention, this object is achieved thanks a material to having the characteristics referred to in the following claims.

In particular, the infill material for turf, subject of the present description, comprises a polymeric matrix of at least one biodegradable biopolymer, at least one vegetable component, and at least one plasticizer.

The biodegradable biopolymer may be selected from the group consisting of polysaccharides, preferably starch, cellulose, lignin, xanthan, curdlan, pullulan; proteins, preferably casein, collagen, gelatin, zein, gluten, chitin; aliphatic polyesters, preferably polylactic acid (PLA), polybutylsuccinate (PBS), polycaprolactone (PCL); aromatic aliphatic copolyesters, preferably polybutyrate-adipate-terephthalate (PBAT); polyhydroxyalkanoates (PHA), preferably polyhydroxybutyrate (PHB), polyhydroxyvaleriate (PHV); polyisoprene or natural rubber; mixtures thereof.

The at least one plant component may be selected from the group consisting of fibers obtained from seeds (e.g. cotton), stems (e.g. hemp, bamboo or flax), leaves (e.g. sisal or banana), bark of trees and plants (for example, coconut husk or rice, coffee silver skin). In a preferred embodiment, the at least one vegetable component comprises wood flour, preferably coming from the processing of conifers and/or broad-leaved trees. The plant component may be presented in fibrous, ground and/or powder form.

The at least one plasticizer may be selected from the group consisting of glycols, sulfonamides, fatty acids, adipates, amides, amines, glyceryl esters, esters, glycerol, sorbitol, diphenylamine, dibutyl sebacate, triphenyl phosphate, citrates, preferably acetyl tributyl citrate (ATBC), vegetable oils, preferably selected from epoxidized soybean oil (ESBO), epoxidized linseed oil (ELO), castor oil, palm oil, cardamom oil, starches, sugars, mixtures thereof, preferably aqueous mixtures thereof.

The infill material may further comprise at least one inorganic filler and/or at least one hydrogel.

The infill material subject of the present description may have a density between 1.20 gr/cm³ and 1.60 gr/cm³.

In one or more embodiments, the infill material subject of the present description may be in particle form.

The disclosure further provides a relative turf comprising a substrate with a plurality of filiform formations extending from the substrate, and the disclosed infill material dispersed among the filiform formations. The turf may be a natural or synthetic turf.

### BRIEF DESCRIPTION OF THE FIGURE

The invention will now be described, purely by way of non-limiting example, with reference to the attached figure wherein a synthetic turf structure comprising the infill material described here is schematically reproduced.

### DETAILED DESCRIPTION OF EXAMPLES OF EMBODIMENTS

In the following description various specific details are illustrated aimed at a thorough understanding of the embodiments. The embodiments may be implemented without one or more of the specific details, or with other methods, components, materials, etc. In other cases, known structures, materials or operations are not shown or described in detail to avoid obscuring various aspects of the embodiments.

The reference to “an embodiment” in the context of this description indicates that a particular configuration, structure or characteristic described in relation to the embodiment is included in at least one embodiment. Therefore, phrases such as “in an embodiment”, possibly present in different places of this description do not necessarily refer to the same embodiment. Moreover, particular configurations, structures or characteristics can be combined in any convenient way in one or more embodiments.

The references used here are only for convenience and do not, therefore, define the field of protection or the scope of the embodiments.

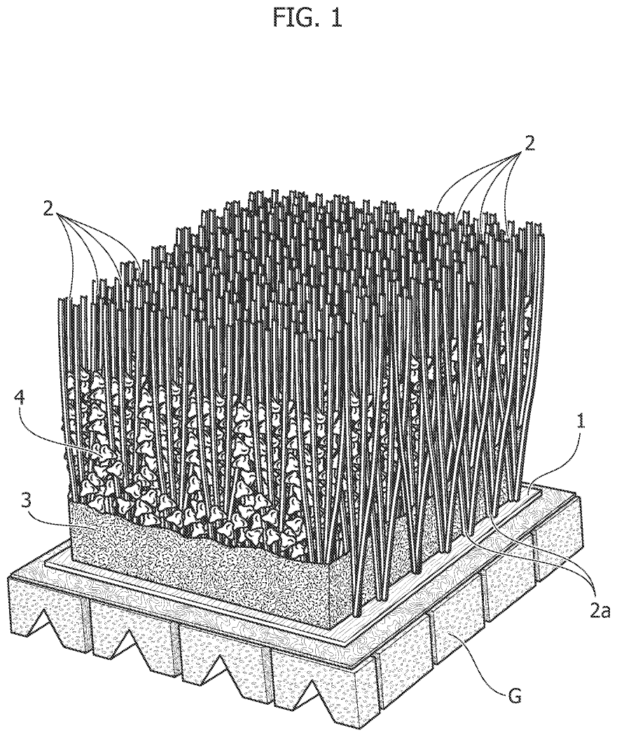

On the basis of a generally known solution, a turf structure, for example, of a synthetic turf, as shown in FIG. 1 comprises a sheet substrate 1 intended to be laid on a substrate G. The substrate G may be, for example, a rammed earth substrate, a rubber mat, a gravel/sand conglomerate substrate, possibly covered with a layer of asphalt, on which the synthetic turf is laid in free laying conditions.

The sheet substrate 1 (currently called “backing”) may consist of a sheet or web of plastic material. Starting from the substrate 1, a plurality of filiform formations 2 extend upwards, usually arranged in clumps or tufts so as to simulate the blades of grass of a natural turf. The filiform formations 2 are anchored to the substrate 1 at their proximal ends, indicated with 2a, and extend upwards with their distal ends for an overall length, measured starting from the general extension plane of the substrate 1, which may range, for example, from 15 millimeters to 70 millimeters, depending on the applications.

The general construction criteria of the substrate 1, and of the filiform formations 2 (including the methods for obtaining the firm anchoring of the proximal ends 2a of the filiform formations 2 on the substrate 1) are known in the art and, therefore, do not require a detailed description here, also because in themselves they relevant are not to the understanding of the invention.

When laying the turf, above the substrate 1, therefore, between the filiform formations 2, an infill material 4—subject of the present description—is dispersed, acting as a filling material (infill).

Furthermore, in contact with the substrate 1, a material consisting mainly of silica sand called “stabilization” infill or ballast, indicated with the reference number 3, may be dispersed, which has the function of weighing down and stabilizing the turf.

The infill material 4 (which can also be defined as “performance”) is the filler layer that gives better technical playing qualities, such as the bounce and rolling of the ball, the ability to cushion blows during running and falling of players.

In addition to contributing to maintaining the filiform formations 2 in an upright condition, preventing them from lying in an undesirable way on the substrate 1, the infill material 4 acts as a shock absorber of falls, as it is able to absorb part of the energy of the fall, thereby counteracting injury to the player.

In the case of a natural turf, the infill material 4 is dispersed in a similar way between the filiform formations of natural grass.

The infill material is dispersed between the filiform formations 2 in a sufficient quantity to ensure that the distal portions of the filiform formations 2 are supported by the filling material for a length so that the distal ends of the filiform formations 2 protrude from the upper surface of the layer of filling material 3 for a length in the order of 5 to 20 millimeters.

In the example of FIG. 1, the filling material 4 is a particulate material (or granular, the two terms being used here as substantially equivalent to each other). It appears as a homogeneous material, formed by granules substantially equal to each other, as they result from a granulation step as better described below.

In one form of use, the infill material 4 is dispersed between the filiform formations 2 in a substantially uniform manner, without giving rise to superimposed layers having different characteristics.

The infill material 4 subject of the present description comprises:
at least one biodegradable biopolymer
at least one vegetable component
at least one plasticizer.

As defined by the European association “European Bioplastics”, the term biopolymer identifies two different types of plastic materials:
Polymers synthesized from renewable sources (biobased material)
Biodegradable and/or compostable polymers according to, for example, EN 13432 or ASTMD 6400 or ISO 17556 standards. It should be emphasized that one definition does not exclude the other, that is, a biopolymer can be biobased, biodegradable/compostable or both.

A polymer is defined as biodegradable in a certain environment if, when dispersed in that environment, it decomposes thanks to the action of bacteria or other microorganisms, into less polluting substances such as carbon dioxide (CO₂) and water (H₂O).

The biodegradable biopolymer contained in the infill material subject of the present description may be selected from the group consisting of polysaccharides, preferably starch, cellulose, lignin, xanthan, curdlan, pullulan; proteins, preferably casein, collagen, gelatin, zein, gluten, chitin; aliphatic polyesters, preferably polylactic acid (PLA), polybutylsuccinate (PBS), polycaprolactone (PCL); aromatic aliphatic copolyesters, preferably polybutyrate-adipate-terephthalate (PBAT); polyhydroxyalkanoates (PHA), preferably polyhydroxybutyrate (PHB), polyhydroxyvaleriate (PHV); polyisoprene or natural rubber; mixtures thereof.

Preferably, the at least one biodegradable biopolymer has a glass transition temperature equal to or lower than the ambient temperature, preferably equal to or lower than 25° C.

In a preferred embodiment, the at least one biodegradable biopolymer comprises, preferably consists of, polybutyrate-adipate-terephthalate (PBAT).

In another embodiment, the at least one biodegradable biopolymer comprises, preferably consists of, at least one of polybutyrate-adipate-terephthalate (PBAT), polylactic acid (PLA), starch, mixtures thereof.

In one or more embodiments, the infill material subject of the present description is free from materials based on polyolefins and materials based on vinyl polymers. In particular, the infill material is free from polymers such as polyethylene (PE), polypropylene (PP), polystyrene (PS), polyvinyl chloride (PVC), polyethylene terephthalate (PET).

In one or more embodiments, the biodegradable biopolymer is present in an amount by weight of between 20% and 90%, more preferably between 25% and 75% with respect to the weight of the filling material.

The at least one plant component can be selected from the group consisting of fibers obtained from seeds (e.g. cotton), stems (e.g. hemp, bamboo or flax), leaves (e.g. sisal or banana), bark of trees and plants (for example, coconut husk or rice, coffee silver skin). The plant component may be presented in fibrous, ground and/or powder form.

The plant component may contain a variable quantity of lignin, cellulose, hemicellulose, relative mixtures.

Preferably, the vegetable component is used in the form of a powder (or flour) comprising particles with dimensions ranging from 75 micrometers to 500 micrometers (μm).

In order to obtain the plant component in the form of powder, it is subjected to grinding and subsequent milling with specific equipment, known in the art.

In a preferred embodiment, the vegetable component comprises, preferably consists of, wood flour, preferably derived from coniferous or broad-leaved wood processing scraps (free from chemical substances such as glues or dyes). In one or more embodiments, the vegetable component can further comprise flour derived from cereal processing waste or from waste coffee.

The at least one plant component can be contained in the infill material in an amount by weight between 5% and 70%, preferably between 10% and 60% with respect to the weight of the infill material.

The filling material further comprises at least one plasticizer which may be totally or partially of natural origin and biodegradable. The plasticizer promotes an increase in flexibility and elongation of the biodegradable biopolymer and—at the same time—reduces the glass transition temperature (Tg). In particular, the degree of freedom of the polymer chains increases with the consequent possibility of rotating around the carbonaceous skeleton, with a consequent increase in flexibility and, therefore, in softness (the biopolymer becomes “rubbery”).

The plasticizer that can be used in the infill material subject of the present description is non-volatile, non-toxic and does not undergo migration as a result of the aging process. The plasticizer acts by causing a decrease in the glass transition temperature and Young's modulus, improving the elastic behavior of the infill material. The presence of the plasticizer, therefore, allows optimization of the elastic performance of the infill material subject of the present description without compromising its biodegradability.

The at least one plasticizer can be selected from the group consisting of glycols, sulfonamides, fatty acids, adipates, amides, amines, glyceryl esters, esters, glycerol, sorbitol, diphenylamine, dibutyl sebacate, triphenyl phosphate, citrates, preferably acetyl tributyl citrate (ATBC), vegetable oils, preferably selected from epoxidized soybean oil (ESBO), epoxidized linseed oil (ELO), castor oil, palm oil, cardamom oil, starches, sugars, mixtures thereof, preferably aqueous mixtures.

In one or more embodiments, the plasticizer can be selected from epoxidized soybean oil (ESBO), acetyl tributyl citrate (ATBC), cardamom oil, relative mixtures.

The plasticizer used in the infill material of the present description modifies the structure of the plant component and improves the mobility and elasticity of the biopolymer.

The at least one plasticizer may be used in an amount by weight between 5% and 60%, preferably between 15% and 50%, with respect to the weight of the infill material.

In a preferred embodiment, the infill material comprises the at least one biodegradable biopolymer and the at least one plasticizer in a weight ratio between 4:1 and 1:2, preferably equal to 1:1.

In one or more embodiments, the infill material may comprise the at least one plasticizer in an amount greater than the amount of the at least one plant component.

One advantage deriving from the use of the plasticizer and, in particular, from the specific quantity in the infill material concerns i) the conferment of specific elastic performances to the material, and consequently to the turf that contains it and ii) a reduced cost of the infill material in question compared to filling materials which, for example, include polymeric biodegradable components but are free of plasticizing compounds.

In one or more embodiments, the infill material subject of the present description may further comprise at least one inorganic filler, preferably selected from the group consisting of calcium carbonate, talc, silica, relative mixtures.

The inorganic filler may be present in an amount by weight comprised between 5% and 40%, preferably between 15% and 45%, with respect to the weight of the infill material.

The different components of the material are bonded and interconnected to form a single phase, the interfacial adhesion between the different components gives the infill material tensile strength and elongation as well as incorporating the plant component and, optionally, the inorganic filler.

In one or more embodiments, the infill material subject of the present description may comprise at least one hydrogel.

The term hydrogel refers to a gelling compound, insoluble in water, which serves to generate a lattice that blocks the water particles, forming a highly absorbent, poly-crosslinked gel, capable of absorbing a liquid, from 50 to 1000 times its weight. In one or more embodiments, the infill material may comprise at least one hydrogel in an amount by weight of between 1% and 30%, preferably between 1 and 15%, with respect to the weight of the filling material.

The hydrogel that may be used in the infill material subject of the present description may be selected from the group consisting of natural compounds, preferably agar, starch; superabsorbent polymers (SAP), preferably polyacrylates, polyacrylamide; related mixtures.

The presence of hydrogel in the infill material subject of the present description allows reduction of the surface temperature of the field in specific conditions of use and favoring the absorption of impacts. This last aspect also plays an important role in light of the consideration that some sports that are practiced on turf involve jumps, accelerations, slips, and changes of direction. During play/sport activity, the lower limbs may be greatly stressed and may tolerate loads that reach at least 3-5 times the weight of the body itself.

In one or more embodiments, the at least one biodegradable biopolymer constitutes a biodegradable polymeric matrix comprising the at least one plant component, the at least one plasticizer and optionally the at least one inorganic filler and/or at least one hydrogel.

With reference to the production method of the infill material subject of the present description, it may comprise the steps of: i) heating and melting the biodegradable biopolymer to form a matrix, ii) adding the vegetable component and the plasticizer to this matrix to obtain a mixture, iii) optionally adding the inorganic filler and/or the hydrogel to the mixture, iv) cooling the mixture to obtain a consolidated material, v) granulating this material to obtain the filling material in the form of granules.

In one or more embodiments, the components of the infill material may be metered and fed into an extruder or mixer at a specific temperature to obtain a blend in the molten state. The extruder may be a twin-screw, counter-rotating/co-rotating extruder.

The granulating step v) may be carried out, for example, by extrusion of the consolidated material. Optionally, a grinding step of the consolidated and extruded material can follow. The material obtained can, for example, have a particle size between 0.5 mm and 5 mm.

The infill material thus obtained may be collected, packaged, transferred to the place of installation to be then “sown” SO as to form a synthetic or natural turf.

The material also has the advantage of being biodegradable on a par with a purely vegetable infill material as—at the end of its life—at least 90% is transformed into carbon dioxide (CO₂) and water (H₂O), without releasing microplastics and components toxic for the environment.

The filling material form in granular thus obtained has substantial characteristics of homogeneity and boasts chemical-physical properties not found in the individual materials that compose it.

Table 1 provides two examples of composition of the infill material subject of the present description.

TABLE 1

Quantity (g)

| | | |
|---|---|---|
| Components | I | II |

| | | | |
|---|---|---|---|
| Biodegradable biopolymer | PBAT | 30 | 50 |
| Vegetable component | Wood flour | 25 | 25 |
| Plasticizer | ESBO | 25 | 25 |
| Inorganic filler | CaCo₃ | 15 | — |
| Hydrogel | SAP | 5 | — |

The compositions I and II referred to in Table 1 were first obtained by melting the biodegradable biopolymer to form a polymeric matrix, and consequently adding the wood flour, the plasticizer (composition I) and also calcium carbonate and SAP (composition II).

In particular, a mixer (batch) for thermoplastic materials, according to the methods commonly adopted in the sector, is heated to a temperature equal to or higher than the melting temperature of the biodegradable biopolymer.

Wood flour and plasticizer may also be pre-mixed before being added to the melted biodegradable biopolymer contained in the mixer.

After cooling, the material leaving the mixer is discharged into an extruder where it is transported, drawn, and transformed into threads, which are subsequently cut into granules. The granules thus produced are left to cool and then subjected to shredding. For this, it is possible to resort to various known techniques such as, for example, shredding in a blade mill, crushing in a hammer mill or the passage of the sheet material through an extruder, followed by granulation as the material comes out of the extruder. The final size of the granules may vary depending on the required application; for example, it may be between 0.5 mm and 5 mm.

The Applicant has conducted experimental tests to measure the resistance of the infill material to repeated use over time. Specifically, tests were conducted in order to reproduce the repeated mechanical stresses that occur during the use of the infill material.

Tests of thermal resistance and degradation at temperature were performed to evaluate the modification of the crystallinity of the biopolymer used in the infill material; a reduction in the crystallinity level of the biopolymer indicates, macroscopically, a reduction in the stiffness of the material. The reduction of stiffness of the material is further obtained by the presence of the plasticizer, which determines an increase in the mobility of the polymer chains.

The Applicant has also carried out experimental tests of volumetric compression of the infill material subject of the present description in order to measure the resistance and deformation values at crushing loads. Experimental comparative tests were conducted on filling materials comprising exclusively vegetable components and performance filling materials comprising exclusively polymeric components based on polyolefins. In particular, the deformation that the material undergoes following crushing (Max deformation) and its elastic return (residual deformation) was evaluated; the lower the elastic return, the lower the degree of compaction of the material. The experimental tests have provided evidence that the infill material subject of this description is less rigid than the comparative vegetable infill material. Furthermore, the degree of compaction is comparable to that of the infill material comprising exclusively polymeric material.

“Creep Recovery” tests were also conducted in order to evaluate the type of deformation (elastic or plastic) following the cyclic application of a load (8 times). In particular, a deformation is considered elastic when there is a return of the material after removal of the load, while a deformation is considered of the plastic type when it is permanent and irreversible after the removal of the load. The lower the value of the ratio between the minimum and maximum deformation (Def. Min/Def. Max), the greater the elastic component of the material and, therefore, its recovery.

Lastly, wear simulation tests were conducted (Lisport for 20200 cycles), or rather, tests that simulate i) the trampling of players “armed” with soccer shoes with cleats and ii) the pressure that each limb of a player places on the surface of a synthetic turf ground. The duration of the test (20200 cycles) provides indications on the durability of the material under standard conditions; 2500 cycles are equivalent to the wear induced by 1 year of use of the synthetic grass turf the comprising infill material. In particular, the abrasion caused by a football boot over time and hours of play is simulated based on the number of cycles. The test results demonstrated a degree of compactness of the infill material subject of the present description comparable to that of a material with only one type of component (monomaterial). During the conduct of the tests, the granule of the infill material maintains its compactness and the inorganic filler remains incorporated in the polymeric matrix, demonstrating the compatibility of the plasticizer, the biopolymer and the inorganic filler to form a single homogeneous and continuous phase.

The infill material for turf subject of the present description is responsive to the concept of environmental sustainability along the entire supply chain, while maintaining the typical performances of a traditional performance filling material comprising rubber or non-biodegradable polymers.

Furthermore, the infill material, thanks to the combination of specific components, has the advantage of not exerting harmful effects on the environment. At the end of its life it does not release microplastics if released or accidentally dispersed in the soil.

During its use, it has a similar performance to filler materials including non-biodegradable polymers or rubber powder, as it includes an elastic component which is preserved even following continuous fatigue cycles. Its ability to withstand the compression of loads and return to the initial conditions is comparable to a performance infill material comprising non-biodegradable polymers, for example based on polyolefins.

The infill material subject of the present description has a density from 1.25 gr/cm³ to 1.5 gr/cm³, higher than that of water. Stagnation and buoyancy phenomena in the case of rain are therefore contrasted.

Of course, without prejudice to the principle of the invention, the details of construction and the embodiments may vary, even significantly, with respect to those illustrated here, purely by way of non-limiting example, without departing from the scope of the invention as defined by the attached claims.

1. Turf infill material comprising:
at least one biodegradable biopolymer,
at least one vegetable component,
at least one plasticizer.

2. Turf infill material according to claim 1, wherein said at least one biodegradable biopolymer is selected from the group consisting of polysaccharides, preferably starch, cellulose, lignin, xanthan curdlan, pullulan; proteins, preferably casein, collagen, gelatin, zein, gluten, chitin; aliphatic polyesters, preferably polylactic acid (PLA), polybutylsuccinate (PBS), polycaprolactone (PCL); aromatic aliphatic copolyesters, preferably polybutyrate-adipate-terephthalate (PBAT); polyhydroxyalkanoates (PHA), preferably (PHB), polyhydroxybutyrate polyhydroxyvaleriate (PHV); polyisoprene or natural rubber; mixtures thereof.

3. Turf infill material according to claim 1, wherein said at least one biodegradable biopolymer comprises, preferably consists of, at least one of polybutyrate-adipate-terephthalate (PBAT), polylactic acid (PLA), starch, mixtures thereof.

4. Turf infill material according to claim 1, wherein said at least one biodegradable biopolymer is present in an amount comprised between 20% and 90%, by weight with respect to the weight of the infill material.

5. Turf infill material according to claim 1, wherein said at least one vegetable component comprises at least one of lignin, cellulose, hemicellulose, mixtures thereof.

6. Turf infill material according to claim 1, wherein said at least one vegetable component comprises, preferably consists of, wood flour, deriving from the processing of conifers and broad-leaved trees.

7. Turf infill material according to claim 1, wherein said at least one vegetable component is present in the form of a powder, said powder comprising particles having a size between 75 micrometers and 500 micrometers (μm).

8. Turf infill material according to claim 1, wherein said at least one vegetable component is present in an amount comprised between 5% and 70% by weight with respect to the weight of the infill material.

9. Turf infill material according to claim 1, wherein said at least one plasticizer is selected from the group consisting of glycols, sulfonamides, fatty acids, adipates, amides, amines, glyceryl esters, esters, glycerol, sorbitol, diphenylamine, dibutyl sebacate, triphenyl phosphate, citrates, preferably acetyl tributyl citrate (ATBC), vegetable oils, preferably selected from epoxidized soybean oil (ESBO), epoxidized linseed oil (ELO), castor oil, palm oil, cardamom oil, starches, sugars, mixtures thereof, preferably aqueous mixtures thereof.

10. Turf infill material according to claim 1, wherein said at least one plasticizer is selected from epoxidized soybean oil (ESBO), acetyl tributyl citrate (ATBC), cardamom oil, mixtures thereof.

11. Turf infill material according to claim 1, wherein said at least one plasticizer is present in an amount comprised between 5% and 60%, weight with respect to the weight of the infill material.

12. Turf infill material according to claim 1, further comprising at least one inorganic filler, preferably selected from the group consisting of calcium carbonate, talc, silica, mixtures thereof.

13. Turf infill material according to claim 12, wherein said at least one inorganic filler is present in an amount comprised between 5% and 40% by weight with respect to the weight of the infill material.

14. Turf infill material according to claim 1, further comprising at least one hydrogel.

15. Turf infill material according to claim 14, wherein said hydrogel is selected from the group consisting of agar, starch; polyacrylates, polyacrylamides, mixtures thereof.

16. Turf comprising a substrate with a plurality of filiform formations extending from a substrate, and an infill material according to claim 1, dispersed between said filiform formations.

17. Turf infill material according to claim 4 wherein said at least one biodegradable biopolymer is present in an amount comprised between 25% and 75%.

18. Turf infill material according to claim 8 wherein said at least one vegetable component is present in an amount comprised between 10% and 60%.

19. Turf infill material according to claim 11 wherein said at least one plasticizer is present in an amount comprised between 15% and 50% by weight with respect to the weight of the infill material.

20. Turf infill material according to claim 13, wherein said at least one inorganic filler is present in an amount comprised between 10% and 35% by weight with respect to the weight of the infill material.
